(19) United States
(12) Patent Application Publication
(10) Pub. No.: US 2023/0140415 A1
(43) Pub. Date: May 4, 2023

(54) Horticulture Smart Driver

(71) Applicant: Open Platform Systems, LLC, Garden City, ID (US)

(72) Inventors: Robert Deely, Garden City, ID (US); George Walter Lewis, Garden City, ID (US)

(21) Appl. No.: 17/936,329

(22) Filed: Sep. 28, 2022

Related U.S. Application Data
(60) Provisional application No. 63/249,187, filed on Sep. 28, 2021.

(51) Int. Cl. A01G 7/04; H05B 45/20

(52) U.S. Cl. CPC A01G 7/045; H05B 45/20

(57) ABSTRACT

A system that is configured for varying light spectrum provided to plants based on sensor input to optimize plant health and growth. Preferred embodiments of the inventive concepts include an infrastructure grid of mesh networked smart drivers as part of the lighting system. The smart drivers communicate with sensors, with other smart drivers on the mesh network, and with control system software that can be implemented as a mobile application or as a cloud based solution.

### PRIORITY/CROSS-REFERENCE TO RELATED APPLICATIONS

This application claims the benefit of U.S. Provisional Application No. 63/249,187, filed Sep. 28, 2021 the disclosure of which is incorporated by reference.

### TECHNICAL FIELD

The herein disclosed and claimed inventive concepts generally relate to an improved system for dynamically adjusting the correct frequency spectrum and intensity of light to indoor plants for optimum health and growth.

### BACKGROUND

The horticulture market is growing rapidly spurred by the legalization of cannabis but also the desire for organic and healthy foods grown without pesticides and chemicals. Indoor greenhouses and vertical farming are a fast-growing industry and need an innovative solution for lighting. Beyond photosynthesis there is photomorphogenesis (form and shape of the plant), phototropism (leaf orientation to maximize photosynthesis), shade avoidance, circadian rhythms, and secondary metabolites (organic compounds that protect the plant).

Photosynthesis occurs when plants absorb optical radiation with wavelengths ranging from 400 nm (deep blue) to 700 nm (deep red). This Photosynthetically Active Radiation (PAR) is important, but plants also respond to ultraviolet radiation (280-400 nm), and far-red radiation (700-800 nm). Like humans, plants have circadian rhythms—they need daily periods of light and darkness. Plants have species-specific requirements for the amount of PAR they receive each day. This is complex because PAR requirements will vary at different points of the plant's life cycle.

The horticulture challenge to solve is dynamically adjusting the correct frequency spectrum and intensity of light to indoor plants for optimum health and growth. This problem is further complicated by different species of plants needing different environments to stimulate growth. Most current horticulture indoor lighting generally only have one wavelength of light or, if full spectrum, the frequencies are not variable and do not control the light based on algorithms best suited for a particular plant. Most current horticulture lights are controlled manually and do not have optimum characteristics or operating parameters for different species of plants and do not dynamically change operation based on sensor inputs to environmental conditions.

### SUMMARY

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined herein.

In the following description and in the figures, like elements are identified with like reference numerals. The use of “e.g.,” “etc,” and “or” indicates non-exclusive alternatives without limitation unless otherwise noted. The use of “including” means “including, but not limited to,” unless otherwise noted.

The preferred embodiments of the disclosed inventive concepts utilize one or more of the following improvements.

Single or multi-channel Smart Drivers in a mesh network that control LEDs (Light Emitting Diodes) of various frequency spectrums that vary light intensity to stimulate and optimize plant growth. Single-channel Smart Drivers can be utilized to control single LEDs or groups of LEDs that are controlled together as a unit. Multi-channel Smart Drivers have distinct channels that allow for separate control of individual LEDs or individual groups of LEDs.

Single or multi-channel Smart Drivers contained within LED lights in a mesh network that control LEDs of various frequency spectrums that vary light intensity to stimulate and optimize plant growth.

Single or multi-channel Smart Drivers remotely connected to the LED lights in a mesh network that control LEDs of various frequency spectrums that vary light intensity to stimulate and optimize plant growth.

Single or multi-channel smart drivers contained within LED lights in a mesh network that are “grouped” to control LEDs of various frequency spectrums in that group that are targeted for a specific species of plant to optimize growth.

Mesh Network Smart Drivers that optimize Photosynthetically Active Radiation (PAR) of various light spectrum frequencies to maximize plant health and growth throughout their life cycle.

Mesh Network Smart Drivers that receive wireless sensor inputs (temperature, PAR, soil moisture and PH, CO2, humidity, ambient light, or other sensor input) to optimize LED light spectrum frequencies to maximize plant health and growth throughout their life cycle.

### BRIEF DESCRIPTION OF THE FIGURES

FIG. 1 is a control diagram of a smart driver having a single LED output or channel.

FIG. 2 is a control diagram of a smart driver having multiple LED outputs or channels.

FIG. 3 is a diagram illustrating a single smart driver with multi-channel outputs controlling three separate LED fixtures of the same or different frequency spectrums.

FIG. 4 is a diagram illustrating a smart driver integral with an LED fixture controlling three LEDs of different frequency spectrums in the fixture.

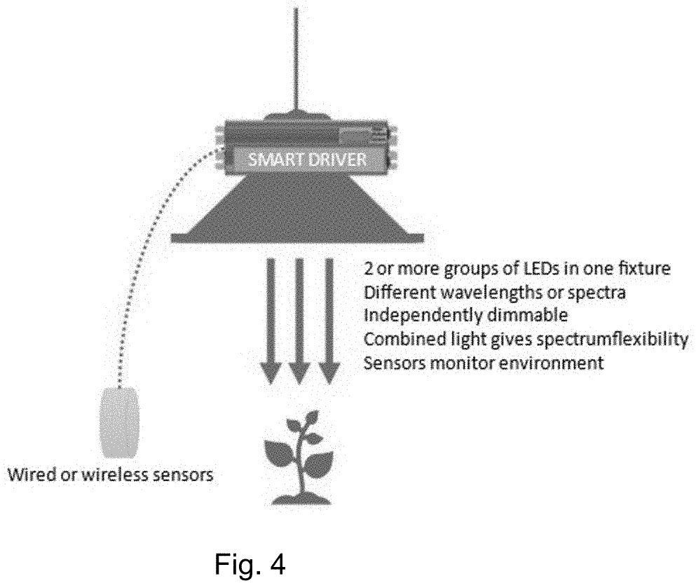

FIG. 5 illustrates three neighboring LED fixtures each controlled by a smart driver with the smart drivers being in wireless mesh network communication with each other. In FIG. 4 a wired or wireless sensors communicate environmental information to each smart driver and associated fixture through the mesh network.

FIG. 6 illustrates three neighboring LED fixtures being controlled by a smart driver positioned remotely from the LED fixtures.

FIG. 7 illustrates a plurality of LED fixtures each controlled by a smart driver.

FIG. 8 illustrates the arrangement of FIG. 7 but with neighboring light smart drivers and associated LED fixtures being segregated.

### DETAILED DESCRIPTION OF FIGURES

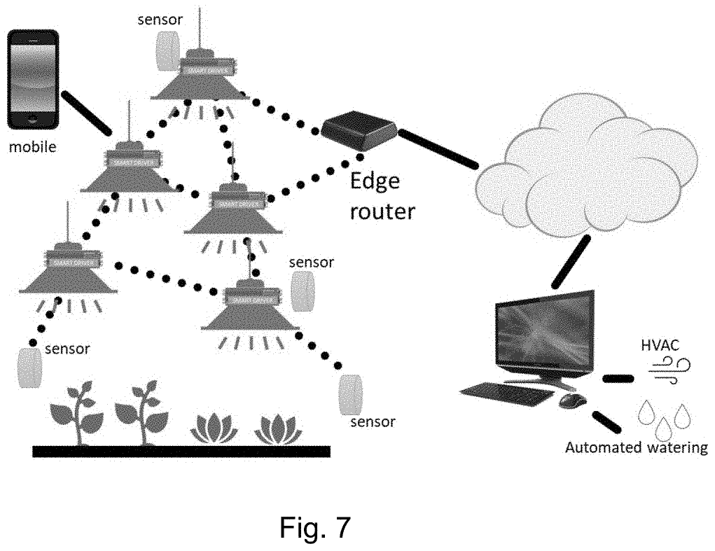

What is disclosed is a novel way of varying light spectrum based on sensor input to optimize plant health and growth. Preferred embodiments of the inventive concepts include an infrastructure grid of mesh networked smart drivers as part of the lighting system. The smart drivers communicate with sensors, with other smart drivers on the mesh network, and with control system software that can be implemented as a mobile application or as a cloud based solution (See, e.g., FIG. 7).

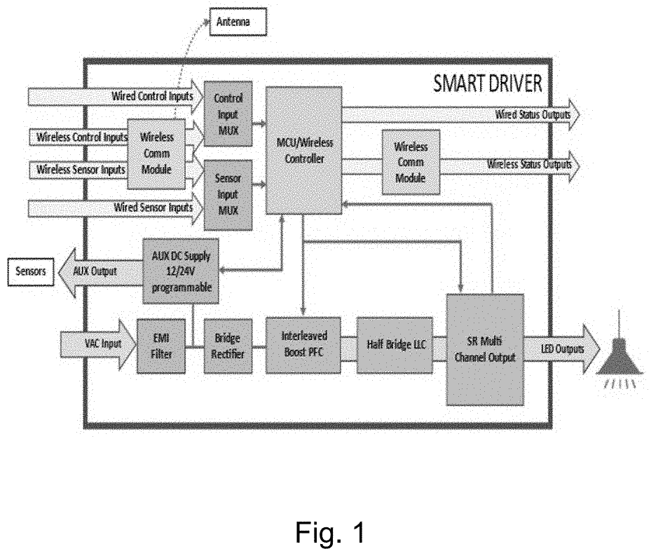

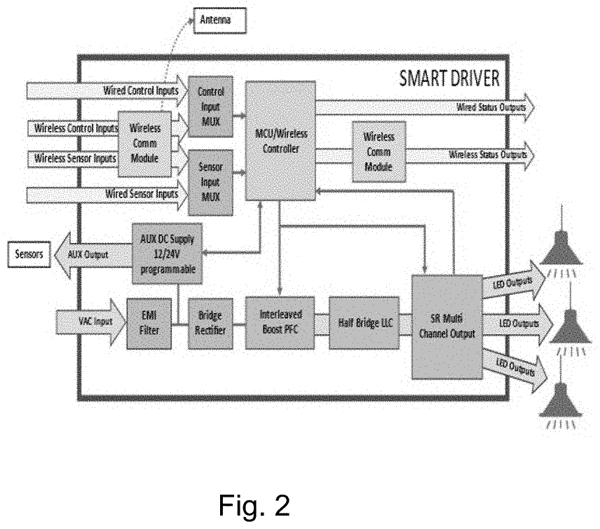

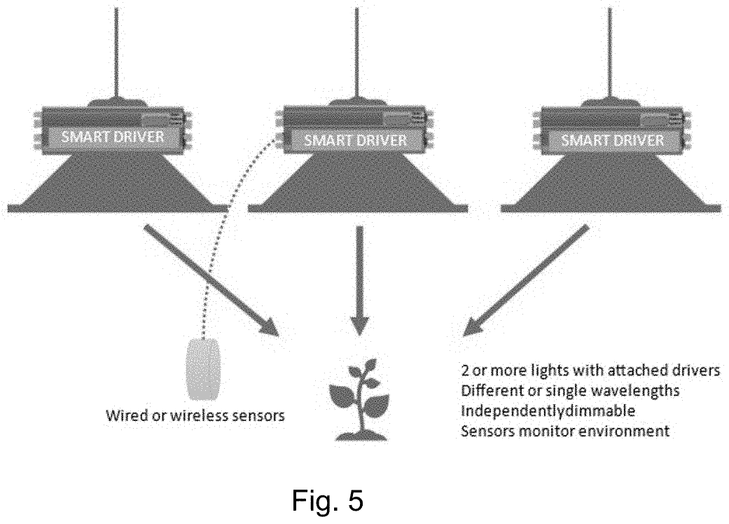

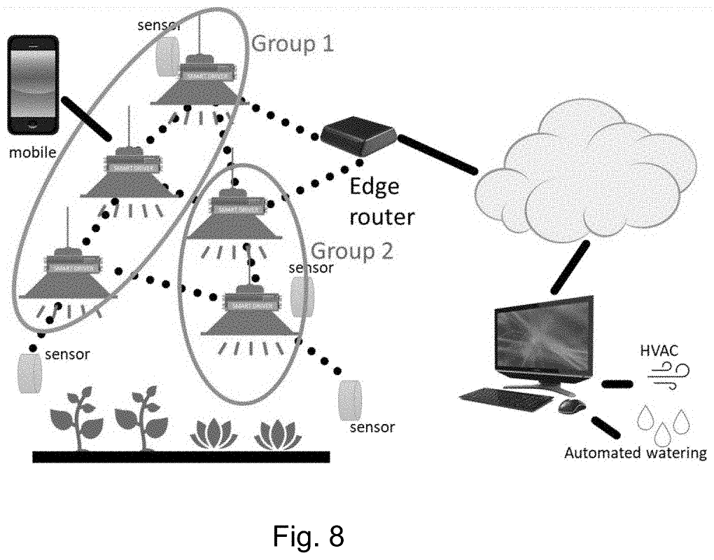

Mobile or cloud based control software allows lights to be grouped with different operating profiles for different plants (See, e.g.,. FIG. 8). Smart Drivers can have a single output (FIG. 1 or 5) or multiple outputs (FIG. 2, 3, 4 or 6) to control LEDs of different wavelengths. The Smart Drivers have a smart microcontroller (labeled MCU/Wireless Controller) that is configured to control the output of the Smart Driver.

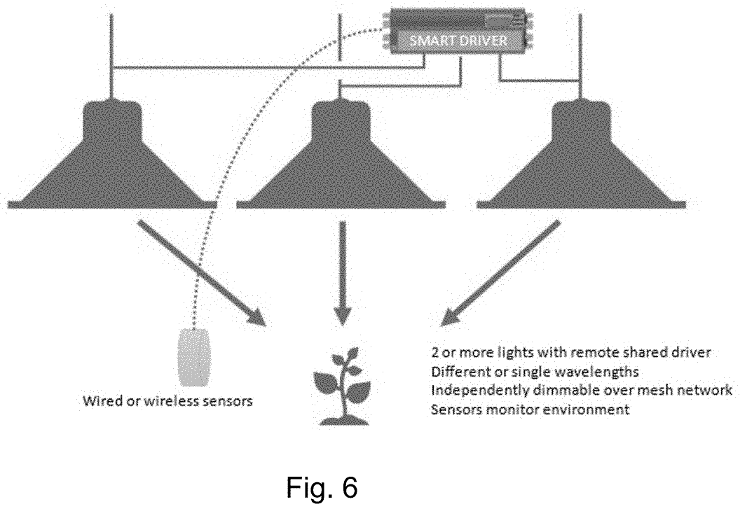

The Smart Drivers can be positioned integrally with the LED light fixtures or remotely from the light fixtures. For example, for vertical farming situations (vertical racks of plants with one or more LED light fixtures for each rack) Smart Drivers can be placed remotely and extension cables connected to the Smart Drivers to reach the LED light fixtures (FIG. 6). This allows the heat from the Smart Driver to be remote from the plants so as to not affect the ambient environment surrounding the plants.

The Smart Drivers can have different profiles to vary light intensity and light spectrums, for example, to meet circadian rhythm requirements of the plants and/or to vary due to light requirements for a species of plant or an individual plant itself. Wireless or wired sensors input data to the smart drivers to control light spectrums, intensity and provide sensor data output to mobile apps or the cloud for human or machine evaluation (see figures).

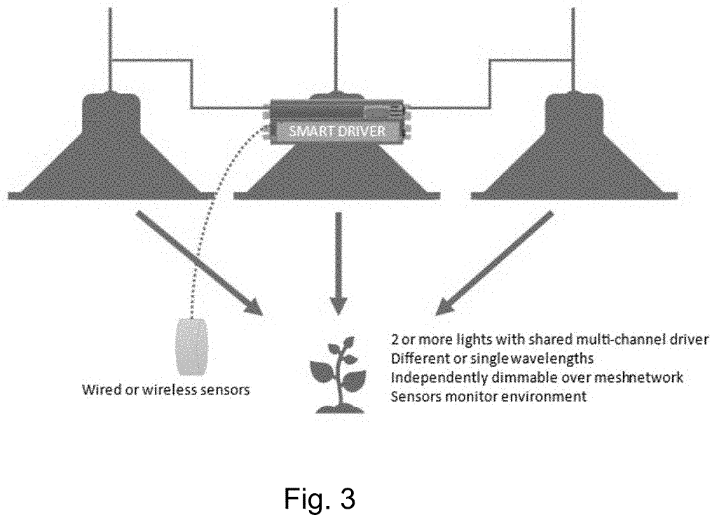

Preferably the Smart Drivers have a low voltage Auxiliary output to provide power to wired sensors or controls. Smart Drivers can be single or multi-channel output. Each Smart Driver output channel controls one LED frequency spectrum of light. Single channel drivers in a light can be configured to communicate to other smart drivers of lights of the mesh network to vary drive current to a LED of each light containing a specific spectrum and to vary the intensity of each LED frequency to meet the PAR requirements for a particular plant (see, e.g., FIGS. 1, 3 5 & 6). Varying light spectrum and intensity from deep blue to deep red based on control software profiles optimize plant growth. Likewise, multi-channel Smart Drivers can control several LED frequencies contained within a single light fixture, or in neighboring light fixtures to meet various PAR requirements for a particular plant (FIGS. 2 & 4). In this method LEDs of different frequencies and/or wavelengths are combined through individual light fixtures or multiple light fixtures to provide an optimum color spectrum for a plant.

Wired or wireless sensors that communicate directly with Smart Drivers may be deployed throughout a facility to collect information on temperature, humidity, soil moisture and PH, CO₂ and PAR readings to vary light fixture output based on plant criteria for maximum growth. Smart Driver micro-processor capability and can perform data analysis and adjustments (edge computing) from sensors independent of mobile or cloud-based applications and control (FIGS. 7 & 8).

Each smart driver is configured to communicate with other smart drivers in a wireless mesh network communication. The smart drivers are connected via a router to a cloud network and a computer controlling ambient environmental conditions of the growing area. A mobile phone, tablet, computer, or other device can be utilized with an app that communicates with the smart drivers to alter the control of the LEDs by the Smart Driver. FIG. 7 illustrates a mobile phone (or “smart phone” communicating with the smart drivers. For the purposes of this document, the term “external computer” is utilized herein to designate any external computerized device, such as a tablet, mobile phone, or computer is referred to as “external computer.” Wired or wireless sensors communicate environmental information to each smart driver and associated fixture through the mesh network.

FIG. 8 illustrates the arrangement of FIG. 7 but with neighboring light smart drivers and associated LED fixtures being segregated to provide two groups that emit differing light frequencies from the other group and being controlled through the mesh network to maximize plant growth and health. Wired or wireless sensors communicate environmental information to each smart driver in each associated group and associated fixture through the mesh network.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

What is claimed is:

1. A smart LED driver for use in horticulture, said smart LED driver comprising:
a power input;
a DC power output configured to provide DC power to a controlled LED, wherein said controlled LED is configured to provide a light spectrum frequency for health and growth of a plant;
a smart microcontroller configured to communicate via a mesh network to neighboring smart microcontrollers that are controlling neighboring LEDs, wherein said smart microcontroller is configured to adjust said DC power output to the controlled LED based on communication with said neighboring smart microcontrollers to maximize plant health and growth in conjunction with light output by said neighboring LEDs.

2. The LED driver of claim 1, wherein said smart LED driver is integral with an LED fixture.

3. The LED driver of claim 2, wherein said LED fixture comprises a plurality of LEDs, wherein said LEDs are configured to emit different spectra of light from neighboring LEDs.

4. The LED driver of claim 2, wherein said LED fixture comprises a plurality of LEDs, wherein said plurality of LEDs are each configured to emit a different wavelength of light from the other LEDs of the plurality of LEDs.

5. The LED driver of claim 1, wherein said smart LED driver comprises multiple DC power outputs and is configured to control a separate LED through each of said multiple DC power outputs.

6. The smart LED driver of claim 1, wherein said smart LED driver is remote from said controlled LED and connected by an extension cable.

7. The smart LED driver of claim 1, wherein said smart LED driver comprises a sensor input, wherein said smart LED driver is configured to receive sensor input and to control said controlled LED based on said sensor input.

8. The LED driver of claim 7, wherein said smart LED driver is configured for sensor input from at least one sensor configured to sense an environmental condition selected from the group consisting of air movement, temperature, PAR (photosynthetically active radiation), soil moisture, soil pH, carbon dioxide, humidity, and ambient light.

9. The smart LED driver of claim 1, wherein said smart LED driver is configured to control said controlled LED based on the species and/or growth stage of said plant.

10. The smart LED driver of claim 7 wherein said sensor input comprises a wired or wireless sensor input.

11. The smart LED driver of claim 1, wherein said LED smart driver further comprising a smart microcontroller input configured for allowing communication between said smart microcontroller and an external computer, wherein said smart microcontroller is configured to adjust control of said controlled LED based on input from the external computer.

12. The smart LED driver of claim 11, wherein said smart microcontroller is configured to adjust control of said controlled LED based on a profile of said plant communicated to said smart microcontroller from said external computer.

13. The smart LED driver of claim 11, wherein said smart microcontroller input is configured for connection to a router.
